(19) United States
(12) Patent Application Publication
(10) Pub. No.: US 2013/0265367 A1
(43) Pub. Date: Oct. 10, 2013

(54) INKJET PRINTER AND PRINTING METHOD

(71) Applicants: Satoshi Kaneko, Tomi-city (JP); Izumi Mizukami, Tomi-city (JP)

(72) Inventors: Satoshi Kaneko, Tomi-city (JP); Izumi Mizukami, Tomi-city (JP)

(73) Assignee: MIMAKI ENGINEERING CO LTD, TOMI-CITY (JP)

(21) Appl. No.: 13/885,162

(22) PCT Filed: Nov. 14, 2011
(86) PCT No.: PCT/JP2011/076170

§ 371 Date: Jul. 1, 2013

(30) Foreign Application Priority Data
Nov. 18, 2010 (JP) 2010-257906
Jul. 4, 2011 (JP) 2011-148421

(51) Int. Cl. B41J 2/145

(52) U.S. Cl. CPC B41J 2/145
USPC 347/37

(57) ABSTRACT

In order to prevent banding between bands printed by an inkjet printer, a print head 2 is moved in a main scanning direction (X) during each scan and the print head 2 is moved in a sub-scanning direction (Y) by a band width (BW) with respect to a print medium 11. The print head 2 includes a nozzle array which is a plurality of nozzles aligned in the sub-scanning direction (Y). The nozzle array is divided into a plurality of path arrays (e.g., P1 to P4) which correspond to a plurality of paths (e.g., 1^{st} to 4^{th} path), respectively, and includes a plurality of skip arrays (e.g., S1 to S3) including non-discharging nozzles and arranged between the plurality of path arrays. The print head 2 is controlled such that nozzles of each path array discharge ink droplets and nozzles of each skip array do not discharge the ink droplets. By doing so, an end of a lower band is misaligned with an end of an upper band formed on the lower band.

### TECHNICAL FIELD

The present disclosure relates to a multipath type inkjet printer and a printing method thereof.

### BACKGROUND ART

The conventional inkjet printers include a print head having a plurality of nozzles aligned in a main scanning direction. One of the recording methods for the inkjet printer is an overlap recording method. The overlap recording method is a recording method in which an image of one single main scanning line is recorded by using different nozzles in several scans in the main scanning direction (for example, refer to Patent Document 1).

One type of the inkjet printers uses a multipath printing method to record image by enabling nozzles corresponding to a plurality of paths to repeatedly scan in the main scanning direction.

A multipath printing method of an inkjet printer will be now described. FIG. 6 shows from a top view printed paths of the inkjet printer by the multipath printing method. FIG. 7 shows the same printed paths from a side view with respect to a recording medium (in a main scanning direction (X)).

A path number for the multipath printing method shown in FIG. 6 and FIG. 7 is set to be four for convenience of explanation. Print head 101 for each scan is shown not aligned in the main scanning direction (X) in order to better show the moving profile of the print head 101 relative to a medium 102.

A nozzle array (not shown) of the print head 101 is divided into four path arrays, the first path array (P1) to fourth path array (P4), and the nozzle array prints paths corresponding to the plurality of the nozzles included in each path array (P1 to P4) as shown in FIG. 6. A printed area made by one scan is a band that has a band width (BW). Four-path printing is made in one single scan after four scans and image that completes four scans is a complete image.

After a scan is completed, the scanning position of the print head 101 is moved by the band width (BW) in a sub-scanning direction (Y) by moving the print head 101 or the printing medium 102 (refer to FIG. 7). Thus, the print head 101 moves by the band width (BW) in the sub-scanning direction whenever printing by the print head 101 completes a scan.

A band is overlapped on the printing medium 102 as shown in FIG. 7. First, a band is formed by the first path array (P1) on the printing medium 102 by the first scan. In the second scan, a band is formed by the first path array (P1) adjacent to the band formed in the first scan on the printing medium 102 and simultaneously, a band is formed by the second path (P2) such that the band by the first scan is overlapped. As such, a new band is overlapped on the band formed by the previous scan whenever a scan is repeated. When four bands are overlapped by four paths, image is complete.

### PRIOR ART DOCUMENTS

### Patent Documents

Patent Document 1: Japanese Patent Laid-open No. 2009-51063 (published on Mar. 12, 2009)

### DISCLOSURE OF INVENTION

### Technical Problem

Since paths are repeatedly made on the same line by the printing method described above, ends of each band lie on the same line. Thus, since a muscle-like pattern (banding) appears at the end portions of the bands, printing quality decreases.

Mechanism causing the banding will now be described in detail. FIG. 8 shows a status after ink droplets 103 are deposited in order to explain the mechanism.

The ink droplets 103 after being deposited on the printing medium 102 are swollen due to the surface tension but gradually spread out and nearly smoothened. Then, adjacent liquid ink droplets are spread out after being contacted. Ultimately, each ink droplet 103 is combined and makes a single ink layer 104. Then, the layer is dried and cured.

The ink droplets 103 are discharged in the next scan while the ink layer 104 becomes cured as shown in FIG. 8(B). The ink layer 104 is made by discharging the ink droplets 103 in an area adjacent to the cured layer 105 on the printing medium 102. Simultaneously, the ink layer 104 is made by discharging the ink droplets 103 on the cured layer 105. Even if the ink layer 104 and the cured layer 105 are contacted on the printing medium 102, they do not mix because the ink layer 104 is liquid and the cured layer 105 is solid. Thus, a boundary 106 is created between them. Since the bottom portion of the ink layer 104 formed on the cured layer 105 is solid, the ink layer 104 does not spread out to the end of the cured layer 105.

Thus, a valley 107 is made between the overlapping cured layers 105 if the cured layer 105 is overlapped on another cured layer 105, as shown in FIG. 8(C). Such valley 107 is considered as a concave portion or a light color portion between the bands.

The inkjet printer in the patent document 1 has the problem described above because layers recorded by each scan are overlapped by the overlap recording method.

The present disclosure is to prevent the banding between bands caused by inkjet printer by the multipath printing method.

### Technical Solution

An inkjet printer according to an embodiment of the present disclosure includes a print head and discharge control means. The print head includes a nozzle array including a plurality of nozzles aligned in a sub-scanning direction perpendicular to a main scanning direction. The discharge control means controls the nozzles to discharge ink droplets such that the nozzles correspond to print data. The inkjet printer performs multipath printing on a print medium with a single scan by moving the print head in the main scanning direction and moving the print head by a band width in the sub-scanning direction with respect to the medium after each scan. The inkjet printer according to the embodiment is characterized in that an image to be printed on the print medium is divided to correspond to a plurality of bands. The print head includes a plurality of path arrays arranged in the sub-scanning direction to correspond to the plurality of bands, respectively, and a plurality of non-discharging areas arranged between the path arrays. The inkjet printer is further characterized in that a length of each non-discharging area in the sub-scanning direction is greater than a distance between two adjacent nozzles in a path array.

According to the embodiment, an image is completed at a band printed by all the path arrays by repeating scanning while moving the print head with respect to the print medium. Since a plurality of non-discharging areas are provided between the path arrays, a blank line (non-recording area) is recorded on a band formed in a previous scan When a scan is performed in each non-discharging area. For this reason, the end of the band formed in a current scan is misaligned with (located on right of) the end of the band formed in a previous scan as shown in FIG. 5. In addition, since a length of each non-discharging area in the sub-scanning direction (d1 shown FIG. 3) is greater than a distance between two adjacent nozzles (d2 shown in FIG. 3), at least one blank line can be formed. On the other hand, no blank line can be formed when the length of each non-discharging area is less than the distance between two adjacent nozzles.

As described above, the end of the band formed in the previous scan is misaligned with the end of the band formed in the current scan even when the print head is moved with respect to the print medium in each scan. Therefore, the ends of the bands are not aligned, the boundaries between the bands are not visible and banding is prevented.

The inkjet printer according to the embodiment can be constructed by following construction (1) or (2).

Construction (1)

It is preferred that each non-discharging area includes one or more nozzles and the discharge control means controls such that the nozzles of each non-discharging area correspond to blank line data. When the nozzles of each non-discharging area correspond to the blank line data by the discharge control means, the nozzles of each non-discharging area do not discharge any ink droplets. Therefore, different non-discharging areas can be formed in two print heads having identical nozzle arrays based on a print condition by changing nozzles that correspond to the blank line data.

Construction (2)

In this construction, each non-discharging area does not include any nozzle. When a print head including such non-discharging areas is used, the control of the print head can be simple and efficient because it is not necessary to match the nozzles of each non-discharging area to the blank line data as described above.

The length of each non-discharging area in the inkjet printer according to Construction (1) or (2) is preferably 10 to 40 times greater than the distance between two adjacent nozzles.

Alternatively, the print head may preferably include a plurality of head units each of which includes at least one path array and the length of each non-discharging area in the sub-scanning direction is preferably greater than the distance between two adjacent nozzles.

Due to the reasons described above, a special print head having a single box member including all the path arrays is not required and commonly available small heads which is generally inexpensive can be used as a head unit. In addition, a print head satisfying various number of paths can be realized by simply changing the number of the head units based on the required number of paths. Furthermore, the print head can be realized by arranging the head units in offset positions.

A printing method for an inkjet printer according to another embodiment of the present disclosure will now be described. The inkjet printer includes a print head which includes a nozzle array including a plurality of nozzles aligned in a sub-scanning direction perpendicular to a main scanning direction. The inkjet printer controls the nozzles to discharge ink droplets corresponding to print data and performs multipath printing on a print medium with a single scan by moving the print head in the main scanning direction and moving the print head by a band width in the sub-scanning direction with respect to the medium after each scan. The printing method is characterized in that bands formed by a same path in each scan are continuously formed on a same layer and an end of a lower band formed in a previous scan is misaligned with an end of an upper band formed on the lower band in a current scan.

According to the printing method described above, an end of the band formed in a previous scan is misaligned with an end of the band formed in a current scan. Since the ends of the bands layered are not aligned, the boundaries of the bands are not visible and banding is prevented.

In the printing method, the nozzle array is preferably divided into a plurality of discharging nozzles arrays and a plurality of non-discharging nozzle arrays. Each non-discharging nozzle array corresponds to blank line data and each discharging nozzle array does not correspond to the blank line data such that the non-discharging nozzle arrays are arranged between the discharging nozzle arrays. Each non-discharging nozzle array corresponds to the blank line data such that a distance between two discharging nozzle arrays is greater than a distance between two adjacent nozzles in a discharging nozzle array.

Therefore, a blank line (non-recording area) is recorded on a band formed in a previous scan when a scan is performed in each non-discharging area. For this reason, the end of the band formed in a current scan is misaligned with (located on right of) the end of the band formed in a previous scan as shown in FIG. 5.

Alternatively, the nozzle array is preferably divided into a plurality of path arrays corresponding to a plurality of bands and may include a plurality of head units each of which includes at least one path array. A plurality of non-discharging areas are arranged between the path arrays, and a length of each non-discharging area in the sub-scanning direction is greater than a distance between two adjacent nozzles in a path array.

Since a plurality of non-discharging areas are provided between the path arrays, a blank line is recorded on a band formed in a previous scan when a scan is performed in each non-discharging area. In addition, since a length of each non-discharging area in the sub-scanning direction is greater than a distance between two adjacent nozzles, at least one blank line can be formed. Therefore, the end of the band formed in the previous scan can be misaligned with the end of the band formed in the current scan even when the print head is moved with respect to the print medium in each scan.

Due to the reasons described above, a special print head having a single box member including all the path arrays is not required and commonly available small heads which is generally inexpensive can be used as a head unit. In addition, a print head satisfying various numbers of paths can be realized by simply changing the number of the head units based on the required number of paths. Furthermore, the print head can be realized by arranging the head units in offset positions.

### Advantageous Effects

Since the inkjet printer according to the present disclosure has improved printing quality by preventing banding between adjacent bands.

### BRIEF DESCRIPTION OF THE DRAWINGS

FIG. 1 shows a top view of a multipath inkjet printer according to the present disclosure;

FIG. 2 shows a side view of main body parts of the inkjet printer;

FIG. 3 shows a top view of a print head of the inkjet printer;

FIG. 4 shows a top view of a printing medium being printed by the multipath inkjet printer;

FIG. 5 shows a cross-sectional area of a printing medium printed by the multipath inkjet printer;

FIG. 6 shows a top view of a printing medium being printed by the conventional multipath inkjet printer;

FIG. 7 shows a cross-sectional area of a printing medium printed by the conventional multipath inkjet printer;

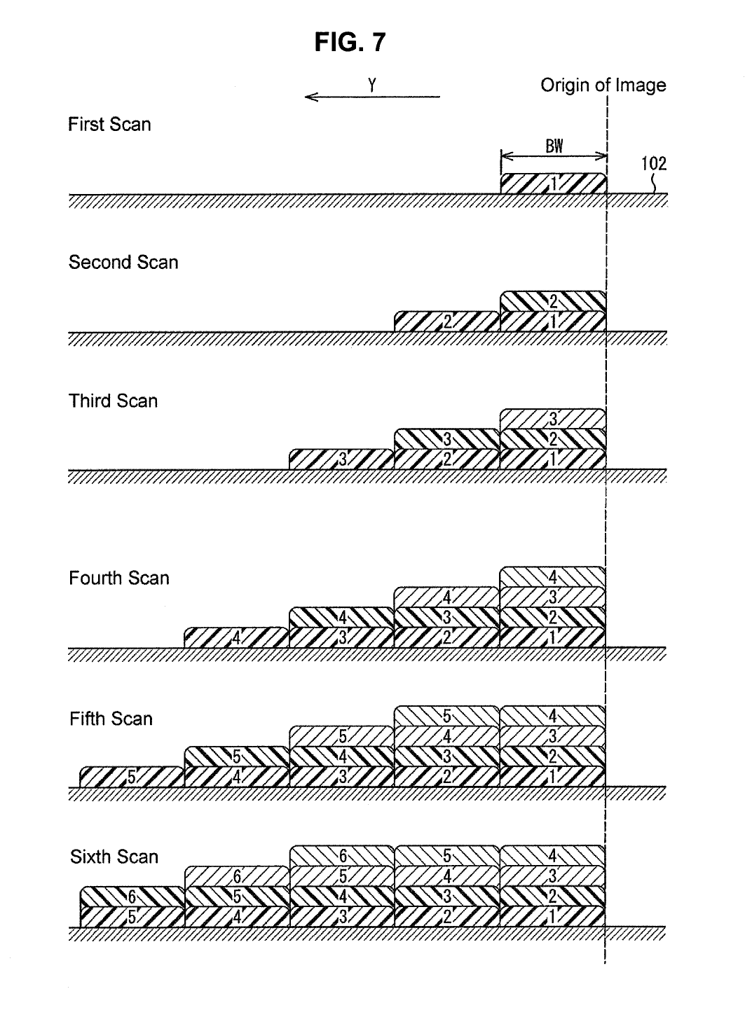

FIG. 8(A) shows cross-sectional areas of ink droplets during depositing, expanding, contacting, and combining to form a single layer, and FIGS. 8(B) and 8(C) show cross-sectional areas of overlapped layers;

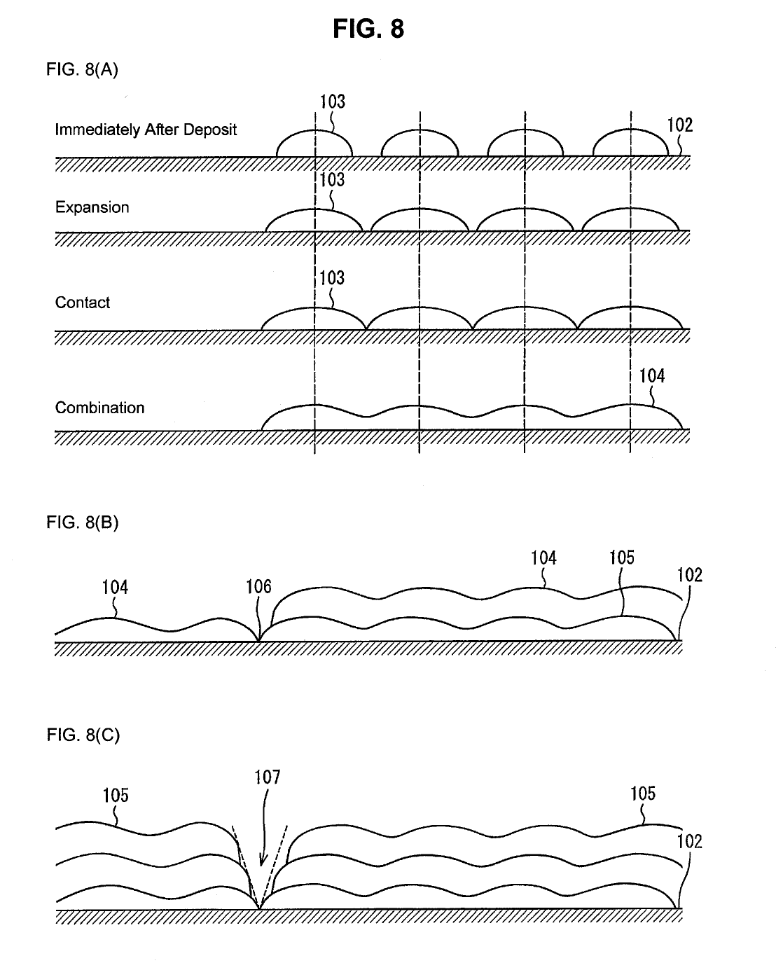

FIG. 9(A) shows a top view of a print head having four head units aligned in the sub-scanning direction and FIG. 9(B) shows a bottom view of the print head;

FIG. 10(A) shows a top view of a print head having four head units arranged as a staggered shape in the sub-scanning direction and FIG. 10(B) shows a bottom view of the print head;

FIG. 11(A) shows a top view of a print head having four head units arranged as a flying geese shape in the sub-scanning direction and FIG. 11(B) shows a bottom view of the print head; and

FIG. 12(A) shows a top view of a print head having four head units aligned in the sub-scanning direction and FIG. 12(B) shows a bottom view of a print head having two head units arranged as a staggered shape in the sub-scanning direction.

### BEST MODE FOR CARRYING OUT THE INVENTION

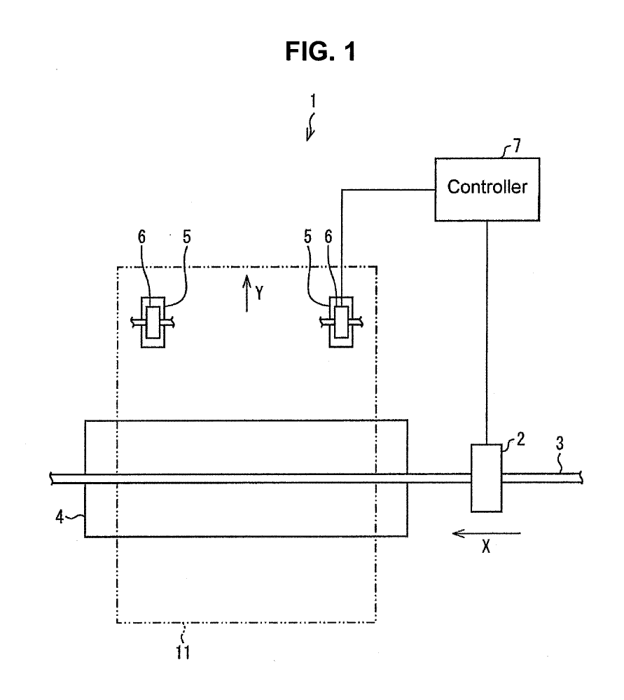

The preferred embodiment according to the present disclosure will now be described with reference to FIG. 1 to FIG. 5 and FIGS. 9(A) and 9(B) to FIGS. 12(A) and 12(B).

[Configuration of Inkjet Printer]

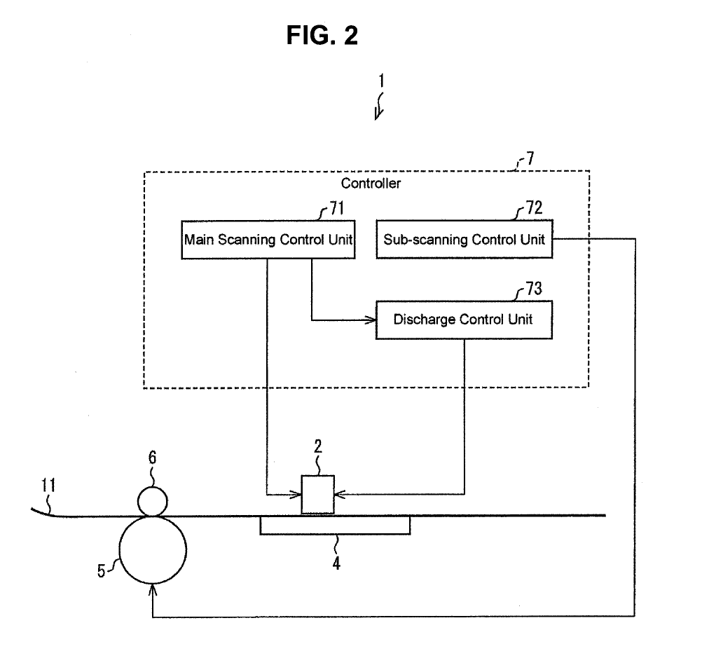

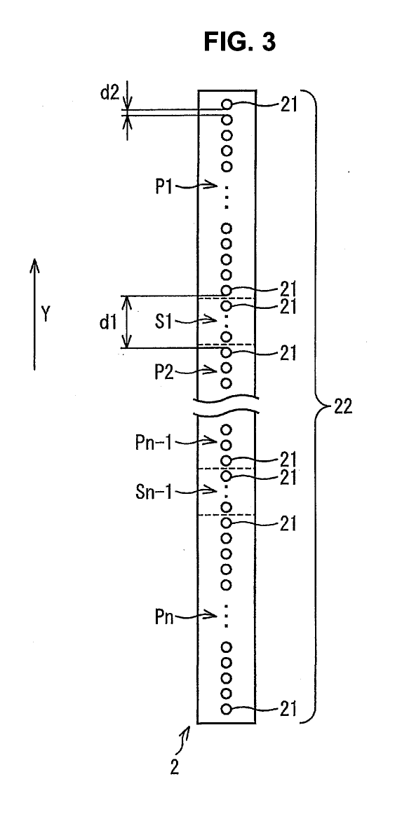

FIG. 1 shows a top view of an inkjet printer 1 according to the present disclosure. FIG. 2 shows a side view of main body parts of the inkjet printer 1. FIG. 3 shows a top view of a print head 2 of the inkjet printer.

The inkjet printer 1 includes the print head 2, a guide rail 3, a platen 4, a feed roller 5, a pinch roller 6, and a controller 7 as shown in FIGS. 1 and 2. This inkjet printer 1 is a printer that records by a multipath printing method. Also, the inkjet printer 1 uses UV curable ink.

The print head 2 discharges ink droplets to a printing medium 11 and moves along the guide rail 3 in the main scanning direction (X) during every scan. An ink-discharging side of the print head 2 faces the printing medium 11 and the print head 2 includes a plurality of nozzles 21 aligned in the sub-scanning direction (Y). The nozzles are form in a nozzle array 22, as shown in FIG. 3.

The nozzle array 22 is divided into the first path array (P1) to the (n)th path array (Pn) (discharging nozzle array) corresponding to the first path to the (n)th path, respectively. Then, if the first path array (P1) to the (n)th path array (Pn) are not specified, it is referred to as a “path array (P)”.

Color discharged from the discharging nozzles laid out in each path array, which is color of ink droplets in each path array discharged from the nozzles 21 (hereinafter, “path array discharging color”), can be same or different. Color discharged from every nozzle 21 of the print head 2 is made same for each print head 2. If a plurality of colors are to be printed, the same number of the print heads 2 as a number of the plurality of color are assembled such that all the colors can be discharged when the assembled print head 2 scans. But, from the perspective of improving printing quality, the path array discharging color or the color discharged from each print head 2 is preferably same for one single scan.

Since the path array discharging color or the color discharged from each print head 2 is the same for one single scan, color of ink droplets, deposited on the printing medium 11, discharged from each path array (P) for one single scan or all the path arrays of the print head 2 is same. Thus, since ink droplets of various colors do not smear when being deposited, brightness of the printed image is well-reserved. Since the order of the discharging colors is same on the same layer of the bands, color change resulted from the different order of the discharging colors between the bands can be prevented.

Each of the first skip array (S1) to the (n−1)th skip array (Sn−1) (non-discharging nozzle array) having one or more nozzles 21 that do not discharge ink droplets is arranged in between two adjacent path arrays (P) of the nozzle array 22. If the skip array (S1) to the (n−1)th skip array (Sn−1) are not specified, it is referred to as a “skip array (S)”.

An area of the first skip array (S1) to the (n−1)th skip array (Sn−1) in the print head 2 is a non-discharging area (area in between adjacent path arrays shown in FIG. 3 (area indicated by d1)).

The nozzles 21 arranged for the path array (P) and the nozzles 21 arranged for the skip array (S) are not fixed but can be adjusted according to printing conditions such as printing quality. The arrangement of the nozzles 21 of the path array (P) and the nozzles 21 of the skip array (S) can be changed when a plurality of scans are performed.

A skip distance d1 (non-discharging area length) between the adjacent path arrays (P) is greater than a nozzle distance d2 between the two adjacent nozzles 21. The skip distance d1 is preferably 10 to 40 times of the nozzle distance d2 and is more preferably 30 times.

A total number (N) of the nozzles which are arranged in the skip arrays (S) is preferably 10 percent of a number of all the nozzles 21. Thus, printing quality can be improved while the decrease of printing speed can be minimized.

The platen 4 is a supporting member arranged in a position that faces the guide rail on which the print head 2 moves. This platen 4 designates the position of the printing medium 11 and includes tools such as an adhesive to fix the printing medium.

The feed roller 5 rotates by a driving force generated through the driving axis and there are two feed rollers 5 arranged a predetermined distance apart in the main scanning direction. The pinch roller 6 rotates in the opposite direction since it is positioned such that it is in contact with the feed roller 5. Two pinch rollers 6 are arranged a predetermined distance apart in the main scanning direction such that they face the feed rollers 5, respectively. The printing medium 11 is inserted between the feed roller 5 and the pinch roller 6 and the printing medium 11 is conveyed a predetermined pitch backward by the feed roller 5 and the pinch roller 6 in the sub-scanning direction (Y) perpendicular to the main scanning direction (X) based on the rotation of the feed roller 5. This pitch is a width (band width) of an area (band) printed by the print head (2) in one single scan in the sub-scanning direction.

The controller 7 includes a main scan control unit 71, a sub-scan control unit 72, and a discharge control unit 73 (discharge control means).

The main scan control unit 71 controls the motion of a motor that drives the print head 2 in order to move the print head 2 in the main scanning direction (X). Since a scan line is changed for every scan, the main scanning control unit 71 outputs a start scan signal before scanning and outputs an end scan signal after scanning.

The sub-scan control unit 72 controls the motion of a motor that moves the printing medium 11 backward in the sub-scanning direction (Y). This sub-scan control unit 72 controls the rotation of the motor such that the printing medium 11 can be moved by the pitch at the end of each scan.

The discharge control unit 73 transmits blank line data to the skip array (S) that does not discharge ink droplets and does not transmit the blank line data to the path array (P) that discharges ink droplets. The skip distance d1 is determined based on a number of the blank lines. The discharge control unit 73 discharges ink droplets from the nozzles 21 of each path array (P) based on print data according to the motion of the print head 2 in the main scanning direction (X). The discharge control unit 73 changes the path array (P) that discharges ink to the next path array (P) based on the start scan signal output from the main scan control unit 71.

The inkjet printer 1 moves the printing medium 11 backward in the sub-scanning direction (Y) but does not move the print head 2 in the sub-scanning direction (Y) in order to move a printing area on the printing medium 11 in the sub-scanning direction (Y). However, the present disclosure is not limited to such configuration as long as the present disclosure moves the print head 2 relative to the printing medium 11.

The inkjet printer 1 does not move but fixes the printing medium 11. The inkjet printer 1 moves the print head 2 relative to the printing medium 11 by moving the print head 2 in the sub-scanning direction (Y). In this case, the feed roller 5 and the pinch roller 6 are not necessary but a tool is required to move the print head 2 in the sub-scanning direction (Y). Such tool can be one that moves the print head 2 along the guide rail 3 in the sub-scanning direction (Y). The sub-scan control unit 72 controls such tool not the feed roller 5.

[Printing Motion by Inkjet Printer]

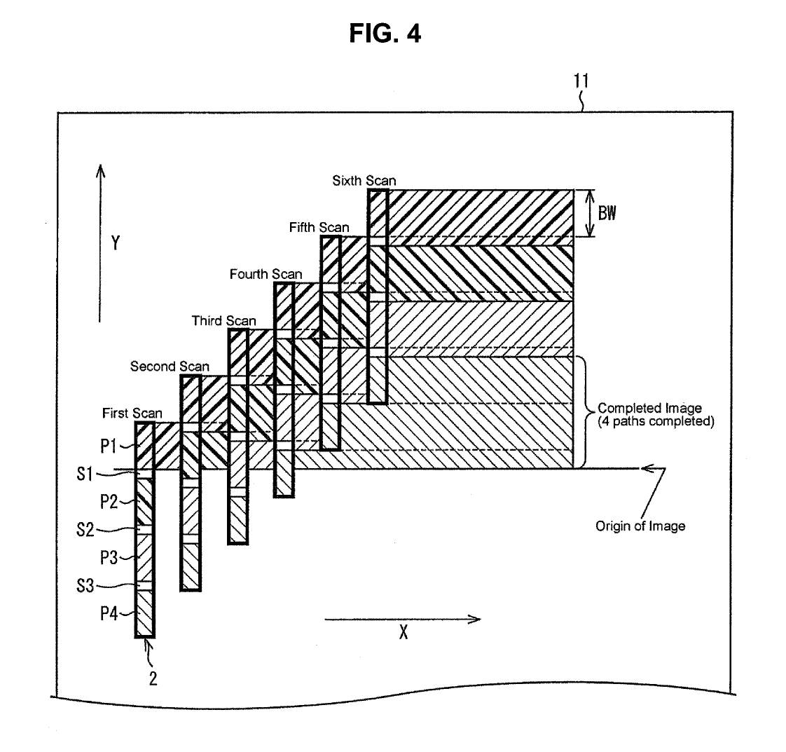

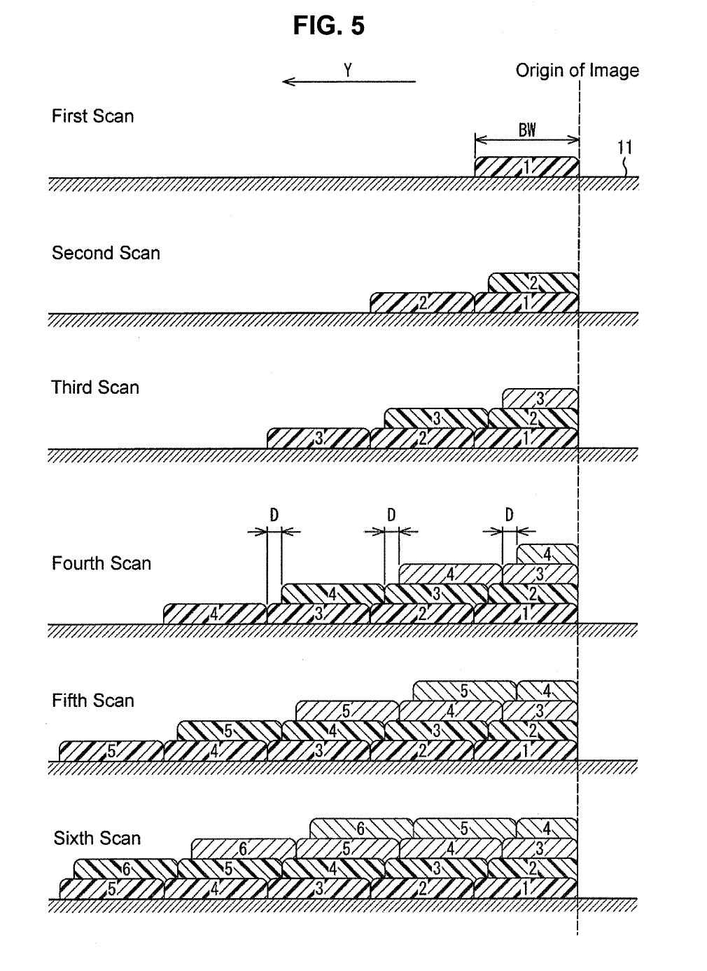

The multipath printing motion of the inkjet printer 1 will now be described. FIG. 4 shows a top view of a printing medium being printed by using the inkjet printer 1 and FIG. 5 shows a side view (from the main scanning direction (X)) of the printing medium printed by a multipath printing method of the inkjet printer

A number (n) of the paths for the printing shown in FIGS. 4 and 5 is four for convenience of explanation. Thus, the nozzle array 22 of the print head 2 is divided into the first path array (P1) to the fourth path array (P4) and has the first skip array (S1) to the third skip array (S3). The print head 2 for each scan is shown not aligned in the main scanning direction (X) in order to show the relative moving profile of the print head 2 relative to the printing medium 11 in FIG. 4.

As shown in FIGS. 4 and 5, printing by the first path array (P1) is made from the origin of image in the first scan. Thus, a band having a band width (BW) is generated on the printing medium 11.

The print head 2 moves by the band width (BW) in the sub-scanning direction (Y) with respect to the printing medium 11 since the printing medium 11 moves backward in the sub-scanning direction (Y) by the band width (BW) in the second scan. Printing by the second path array (P2) and the first path array (P1) is formed from the origin of image. Thus, a new band is formed adjacent to the band formed in the first scan and another band is formed on the band formed in the first scan.

Furthermore, printing by the third path (P3), the second path (P2), and the first path (P1) is made from the origin of image in the third scan while the print head 2 moves by the band width (BW) in the sub-scanning direction with respect to the printing medium 11 (similar to previous scan). Thus, a new band is formed adjacent to the band formed in the second scan and another band is formed on the band formed in the second scan on the printing medium 11.

Printing by the fourth path (P4), the third path (P3), the second path (P2), and the first path (P1) is made from the origin of image in the fourth scan while the print head 2 is moved (similar to previous scan). Thus, a new band is formed adjacent to the band formed in the third scan and another band is formed on the band formed in the third scan on the printing medium 11.

The scans are repeated by moving the print head 2 with respect to the printing medium 11. Thus, bands formed by the same path on each scan are continuously formed on the same layer and image is completed if printing by the first path array (P1) to the fourth path array (P4) is made. Since each of the skip arrays (S) is arranged between two adjacent path arrays (P) in the print head 2, a blank line (no recording area) is made on the band formed in the previous scan. Thus, as shown in FIG. 5, the end of a band in the current scan is formed not aligned by D with the band formed in the previous scan (dotted lines in FIG. 4). At least one blank line can be made since the distance (d1) between the skip arrays (S) is greater than the distance (d2) between the adjacent nozzles. On the other hand, if the distance (d1) between the skip arrays (S) is shorter than the distance (d2) between the adjacent nozzles, the blank line cannot be realistically made.

If multi-color printing by the print head 2 for each color is made, ink droplets of all the colors are preferably discharged by scanning all the print heads 2 in one single scan from the perspective of printing speed. However, from the perspective of improving printing quality, ink droplets of only one color are preferably discharged in one single scan. For example, for printing by cyan and magenta ink, when cyan ink is discharged in the first scan, the first layer of cyan ink is made since the cyan ink droplets are deposited on the printing medium 11. When magenta ink is discharged in the second scan, the second layer of magenta is made since magenta ink droplets are further deposited on the printing medium 11. This is similar to the first scan when the discharging color is only one single color.

Thus, since ink droplets discharged from each path array (P) do not smear inside the band when being deposited, the brightness of the printed image is well-reserved. Also, since the extent to which ink droplets deposited on the band of the lower layer are spread out is not different between the bands on the same layer, color change between the bands can be prevented.

If the path array discharging color is not one single color, following problems occur. First, ink droplets discharged from each path array (P) is spread out when being deposited. Second, colors are deposited between the bands on the same layer in a different order. Thus, since the extent to which ink droplets deposited on the bands of the lower layer are spread out is different between the bands on the same layer, color change occurs. The path array discharging color is preferably one single color in order to not damage the printed image.

### GENERAL EMBODIMENTS

The nozzle array 22 of the print head 2 is divided into the path arrays (P) corresponding to each path and each boundary between the two adjacent bands for each layer is in a different position from each other since each of the skip arrays (S) is arranged in between the two adjacent path arrays (P). In detail, the upper layer (second layer) band corresponding to the lower layer (first layer) band is formed in the second and third scans, as shown in FIG. 5. In other words, one band formed in the third scan is printed such that it corresponds to the bands formed in the first and the second scans.

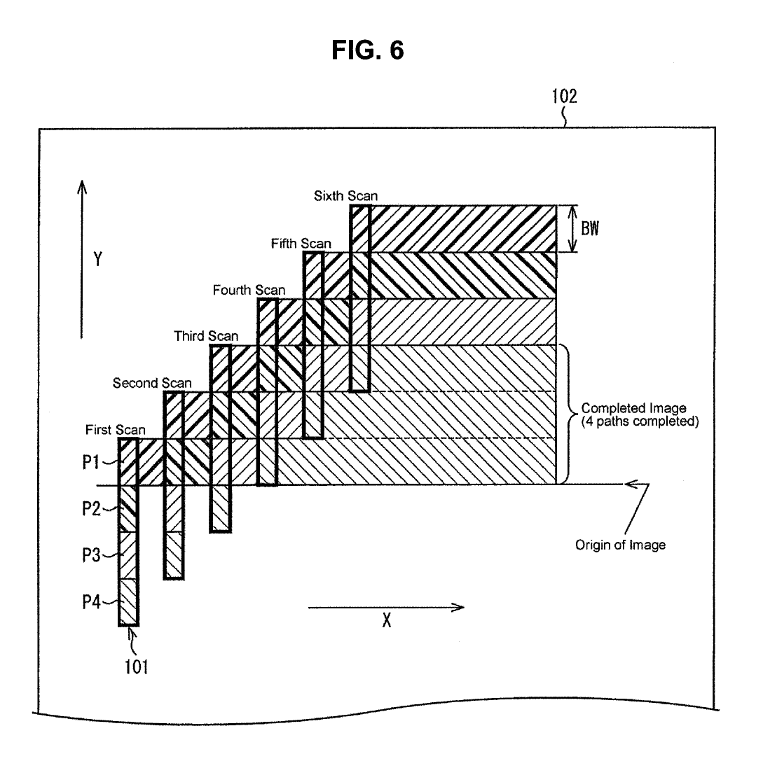

Thus, even if the print head 2 moves by the band width (BW) with respect to the printing medium (11) (similar to printing method of conventional inkjet printer shown in FIG. 6), the end of the band formed in the previous scan and the end of a band formed in the current scan on the band formed in the previous scan are not aligned. Thus, since the ends of the bands on each layer cannot be on the same array during printing, each boundary between the two adjacent bands is not visible and banding can be prevented.

Printing speed decreased only 5 to 10% when the print head 2 having 300 DPI nozzle arrays is used to print by the printing method described above. Printing speed does not decrease much and printing quality can be improved by the printing method described above.

The nozzles 21 arranged for the path arrays (P) and the nozzles arranged for the skip arrays (S) are not fixed but can be adjusted according to printing conditions such as printing quality. Thus, the discharge control unit 73 that corresponds print data to the nozzles 21 of each path array (P) needs to be controlled and the positions of the blank lines can be changed according to various printing conditions.

### Modified Embodiment 1

Although each boundary between the two adjacent bands of each layer is not aligned because the skip arrays (S) are arranged in the print head 2, the present disclosure is not limited to such configuration. For example, the inkjet printer 1 can have a print head that does not include the nozzles 21 for the non-discharging area (area corresponding to distance d1 between skip arrays) between the two adjacent path arrays (P). The non-discharging area length of this print head is greater than the distance (d2) between the two adjacent nozzles.

If this print head is used, the control of the controller 7 can be simplified because the discharge control unit 73 does not need to correspond print data to the nozzles 21 of each path array (P). The blank lines of the print head arranged by the non-discharging area that does not include the nozzles 21 are fixed but the blank lines can be changed according to printing conditions if the non-discharging nozzles are set up. For example, for a print head having four path arrays divided by the non-discharging areas which do not include the nozzles 21, blank lines can be created by having the nozzles 21 arranged in the middle of the path array (P) as non-discharging nozzles. Such print head can have blank lines according to the printing conditions.

### Modified Embodiment 2

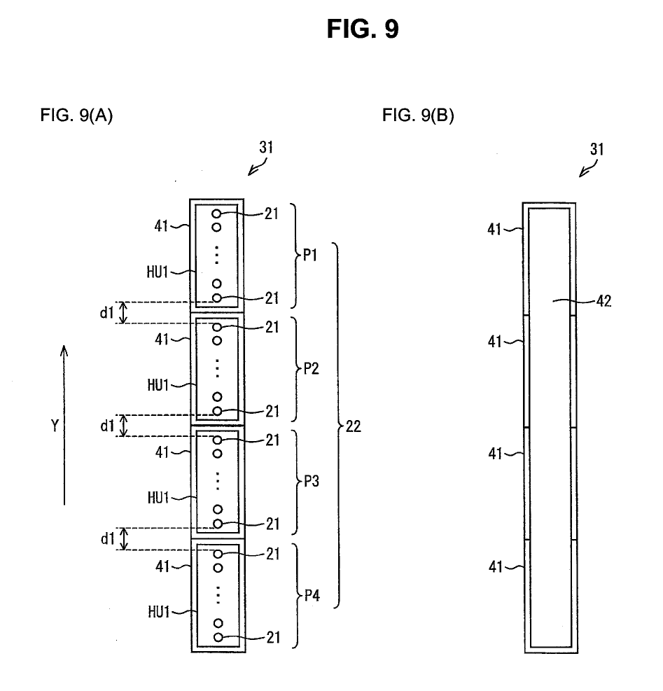

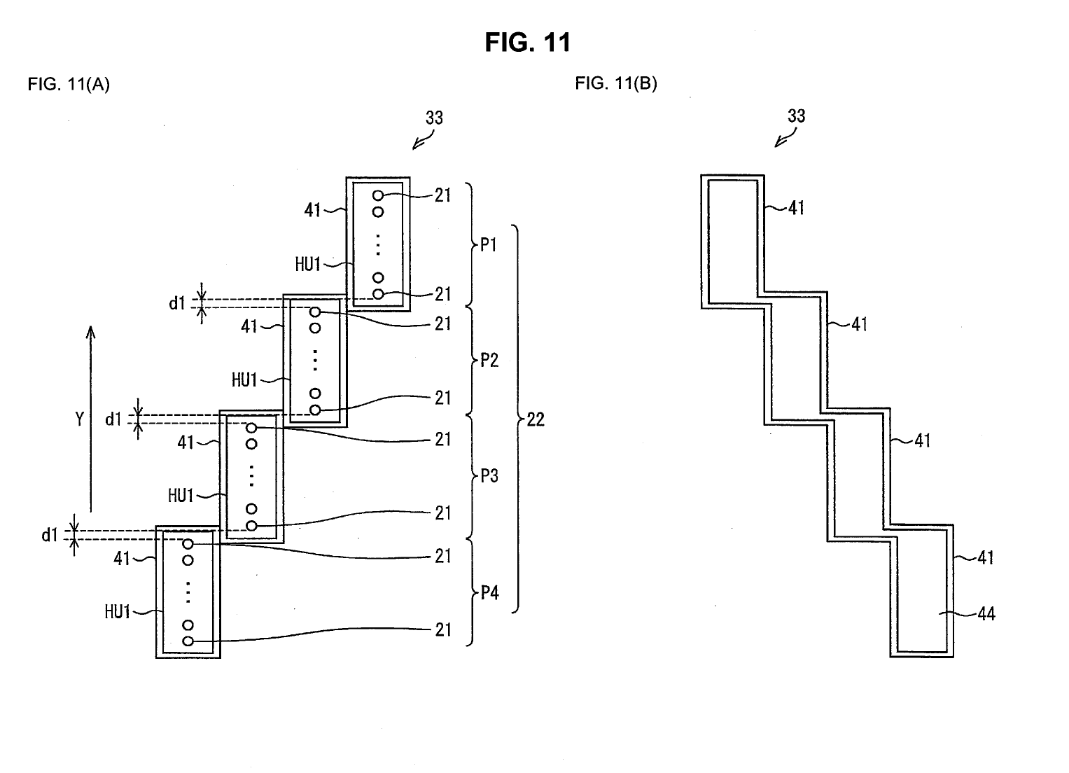

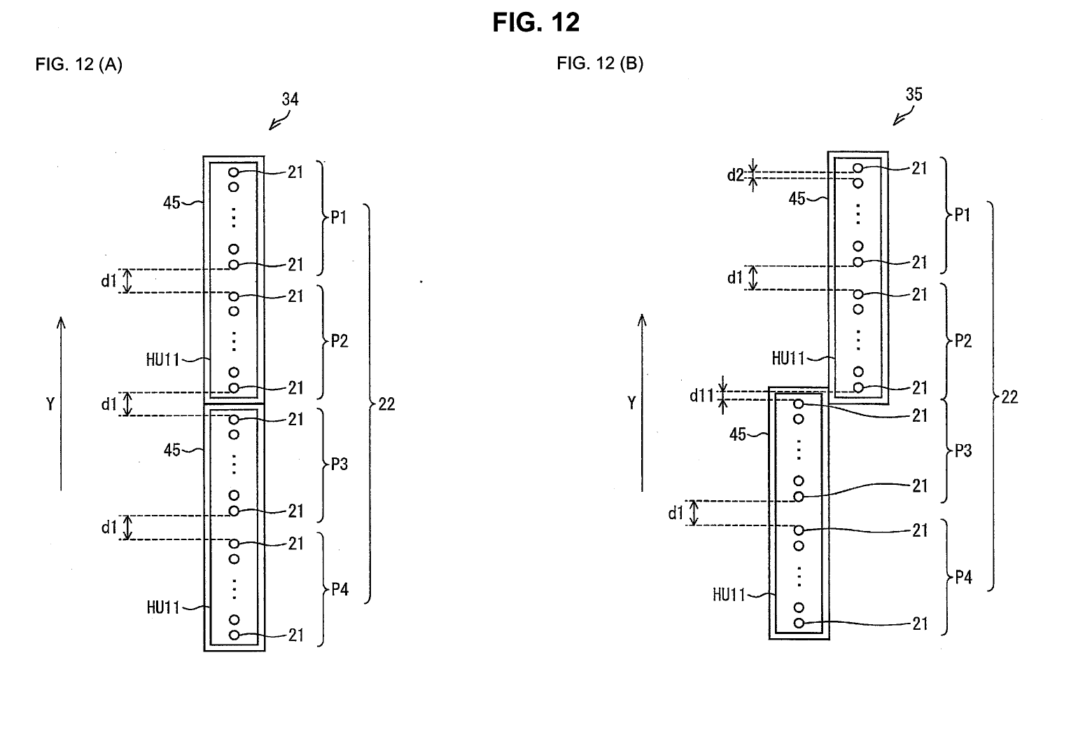

FIG. 9 (FIGS. 9(A) and 9(B)) to FIG. 11 (FIGS. 11(A) and 11(B)) show another print heads 31 to 33 according to the modified embodiment 2. FIG. 12 (FIGS. 12(A) and 12(B)) shows the print heads 34 and 35 according to the modified embodiment 2.

The nozzle array 22 of the inkjet printer 1 includes the print head 2 made by a single box member but instead of the print head 2, at least one of the print heads 31 to 35 can be included.

[Print Head by Four Head Units]

The print head 31 includes four head units (HU1) as shown in FIGS. 9(A) and 9(B). A plurality of the nozzles 21 are aligned in each head unit (HU1) and simultaneously the head units (HU1) are inserted into a head case 41 while a nozzle surface on which the nozzles 21 are arranged is exposed. Each head unit (HU1) is assembled aligned since the bottom surface of the head case 41 is fixed by a head assembly member 42. The head assembly member 42 is a long rectangular flat panel member.

The nozzles 21 of a head unit (HU1) at one end correspond to the first path array (P1) and the nozzles 21 of a head unit (HU1) adjacent to the head unit (HU1) correspond to the second path array (P2). The nozzles 21 of a head unit (HU1) at the other end correspond to the fourth path array (P4) and the nozzles 21 of a head unit (HU1) adjacent to the head unit (HU1) correspond to the third path array (P3). The adjacent path arrays (P) are the skip distance d1 apart in the sub-scanning direction (Y) and an area between the path arrays (P) that do not have the nozzles 21 is the non-discharging area. The print heads 32 and 33 have the same correlation of the nozzles 21 of each head unit (HU1) and the path arrays (P) and has the non-discharging area that is an area between the path arrays (P).

The print head 31 has the nozzles 21 of each head unit (HU1) arranged in the sub-scanning direction. The nozzle array 22 of the print head 31 is arranged by the nozzles 21 (the first path array (P1) to the fourth path array (P4)) of the four assembled head units (HU1).

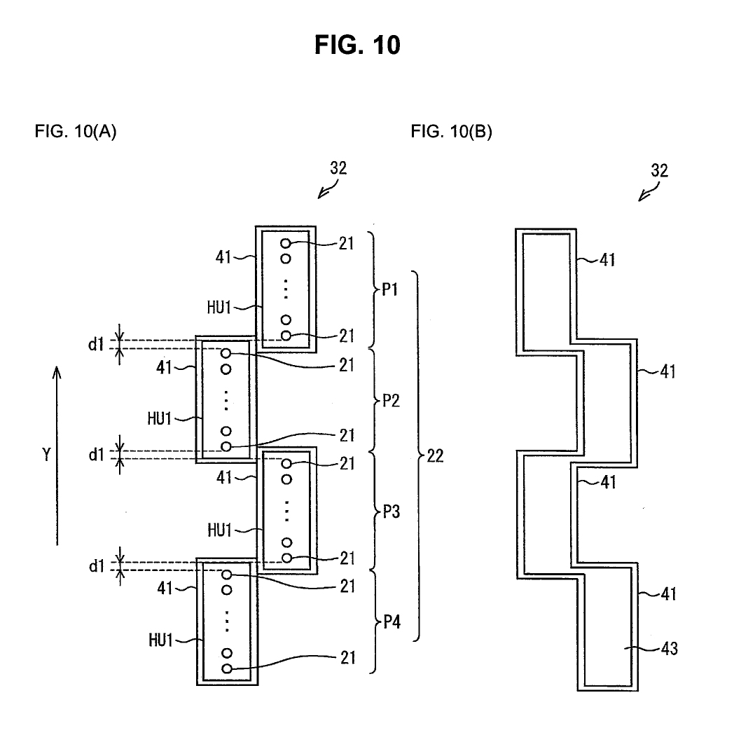

The print head 32 has four head units (HU1) as shown in FIGS. 10(A) and 10(B). Each head unit (HU1) of the print head 32 is assembled such that it is misaligned in the direction perpendicular to the sub-scanning direction (Y), so-called staggered arrangement (zigzag arrangement), since the bottom surface of the head case 41 is fixed on the head assembly member 43. The head assembly member 43 is a flat panel member as a staggered shape. Two adjacent head cases 41 are contacted at the ends of their longer sides.

The print head 32 includes the nozzles 21 of each head unit (HU1) arranged in the sub-scanning direction (Y). The nozzle array 22 of the print head 32 is arranged by the nozzles 21 (the first path array (P1) to the fourth path array (P4)) of the four assembled head units (HU1) as a staggered shape.

The print head 33 has four head units (HU1) as shown in FIGS. 11(A) and 11(B). Each head unit (HU1) of the print head 33 is assembled such that it is misaligned in the direction perpendicular to the sub-scanning direction (Y), so-called stepped arrangement, since the bottom side of the head case 41 is fixed on the head assembly member 43. The head assembly member 44 is a flat panel member as a stepped shape. The two adjacent head cases 41 are contacted at the ends of their longer sides.

The print head 33 has the nozzles 21 of each head unit (HU1) arranged in the sub-scanning direction. The nozzle array 22 of the print head 33 is arranged by the nozzles 21 (the first path array (P1) to the fourth path array (P4)) of the four assembled head units (HU1) as a stepped shape.

The print heads 31 to 33 include four head units (HU1) corresponding to the first path array (P1) to the fourth path array (P4), respectively. Thus, there is no need to have a special long print head 2 as shown in FIG. 3 and regular small size head units (HU1) corresponding to the path arrays (P) can be used. The print heads 31 to 33 can be obtained at a cheaper price than the print head 2. The number of head units (HU1) can be changed according to the required number of paths. Further, any desired shape of the print head can be obtained by arranging the head units (HU1) misaligned like the print heads 32 and 33.

The head units (HU1) are arranged such that the head cases 41 of the print heads 32 and 33 are contacted side to side. Thus, the total length of the print heads 32 and 33 in the sub-scanning direction (Y) can be shorter than the total length of the print head 31 in which the head units (HU1) are aligned.

Although the head units (HU1) of the print heads 31 to 33 are assembled by the head assembly members 42 to 44, the assembly structure of the head units (HU1) is not limited to such structure described above. For example, each head unit (HU1) can be assembled by the head cases 41 that each head unit (HU1) can be individually inserted into.

According to the present modified embodiment, although FIG. 9 (FIGS. 9(A) and 9(B)) to FIG. 11 (FIGS. 11(A) and 11(B)) show the assembly of the head units 31 to 33, their assembly is not limited to such assembly but can be various types of the assembly.

[Print Head by Two Head Units]

The print head 34 has two head units (HU11) as shown in FIG. 12(A). Each head unit (HU11) has a plurality of the nozzles 21 arranged in a straight line and simultaneously, the head units (HU1) are inserted in the head case 45 while a nozzle surface on which the nozzles 21 are arranged is exposed. Although each head unit (HU11) is not shown, each head unit (HU11) is assembled in a straight line since the bottom surface of the head case 45 is fixed by the head assembly member 42.

The nozzles 21 of one head unit (HU11), which is arranged on one end portion of the print head 34, close to the center of the nozzle array 22 correspond to the second path array (P2) and the nozzles 21 on the other portion of the head unit (HU11) correspond to the first path array (P1). The nozzles 21 of the other head unit (HU11), which is arranged on the other end portion of the print head 34, close to the center of the nozzle array 22 correspond to the third path array (P3) and the nozzles 21 on the other end portion of the other head unit (HU11) correspond to the fourth array (P4).

Since the first path array (P1) and the second path array (P2) are the skip distance (d1) apart, an area between the first and the second path arrays (P1) and (P2) is referred to as the non-discharging area. Since the third path array (P3) and the fourth path array (P4) are the skip distance (d1) apart, an area between the third and the fourth path arrays (P3) and (P4) is referred to as the non-discharging area. A distance between the adjacent second path array (P2) and third path array (P3) can be the skip distance (d1) which is the non-discharging area.

The non-discharging area of the head units (HU11) can have the nozzles 21 that can be the skip array (S) like the print head 2 shown in FIG. 3 or does not have the nozzles 21 like the modified embodiment 1. It is obvious that there are no nozzles 21 in the non-discharging area created between the two head units (HU11).

Such print head 34 includes the nozzles 21 of each head unit (HU11) arranged in the sub-scanning direction (Y). The nozzle array 22 is created by the nozzles 21 (first path array (P1) to fourth path array (P4)) of the two assembled head units (HU11).

The print head 35 includes two head units (HU11) as shown in FIG. 12(B). Although each unit (HU11) is not shown, each head unit (HU11) is assembled not aligned since the bottom surface of the head case 45 is fixed to a head assembly member. The head assembly member like the head assembly member 44 has a stepped shape that corresponds to the two head units (HU11). The two adjacent head cases 45 are contacted at the ends of their longer sides.

Although not shown, each head unit (HU11) can be misaligned in the opposite direction of the head units (HU11) shown in FIG. 12(B).

The nozzles 21 of one head unit (HU11), which is arranged on one end portion of the print head 35, close to the center of the nozzle array 22 correspond to the second path array (P2) and the nozzles 21 on the other end portion of the head unit (HU11) correspond to the first path array (P1). The nozzles 21 of the other head unit (HU11), which is arranged on the other end portion of the print head 35, close to the center of the nozzle array 22 correspond to the third path array (P3) and the nozzles 21 on the other end portion of the other head unit (HU11) correspond to the fourth array (P4).

Since the first path array (P1) and the second path array (P2) are the skip distance (d1) apart, an area between the first and the second path arrays (P1) and (P2) is referred to as the non-discharging area. Since the third path array (P3) and the fourth path array (P4) are the skip distance (d1) apart, an area between the third and the fourth path arrays (P3) and (P4) is referred to as the non-discharging area. A distance between the adjacent second path array (P2) and third path array (P3) is shorter than the skip distance (d1) in the sub-scanning direction (Y) unlike the distance between the second and third path arrays (P2) and (P3) of the print head 34. The distance between the adjacent second path array (P2) and the third path array (P3) is referred to as a skip distance (d11), which is a non-discharging area. However, the skip distance (d11) (non-discharging area length) like the skip distance (d1) is greater than the nozzle distance (d2).

The non-discharging area of the head unit (HU11) like the print head 34 can have the nozzles 21 or does not need to have the nozzles 21. It is obvious that there are no nozzles 21 between the two head units (HU11), which is the non-discharging area. If the skip distance (d11) (non-discharging area length) is not sufficient for the desired blank line, the nozzles 21 that are adjacent to the non-discharging area can be used or the desired skip distance (d11) can be obtained by changing the distance between the head units.

If the nozzles 21 corresponding to the skip arrays (S) are arranged in the non-discharging area of the head units (HU11), a number and positions of the skip arrays (S) can be determined by the data distribution of the blank lines. Thus, more than three path arrays (P) of the head units (HU11) can be arranged.

Such print head 35 includes the nozzles 21 of each head unit (HU11) arranged in the sub-scanning direction (Y). The nozzle array 22 of the print head 35 is arranged misaligned by the nozzles 21 (the first path array (P1) to the fourth path array (P4)) of the two assembled head units (HU11).

The print heads 34 and 35 are assembled as one print head by assembling two head units (HU11) that has a set of the first path array (P1) and second path array (P2), and another set of the third path array (P3) and the fourth path array (P4). Thus, there is no need to have a long and special print head 2 but a head used for a regular inkjet printer can be used as the head unit (HU11) even though it is bigger than the head unit (HU1). Thus, it cost less money to assemble the print heads 34 and 35 than the print head 2. Since a number of the head units (HU11) that increase by a number of paths can be changed, desired print heads can be realized according to the number of paths. Moreover, by arranging the head units (HU11) like the print head 35 misaligned, the desired print head can be obtained.

Like the print heads 31 to 33, the assembling structure of the head units (HU11) of the print heads 34 and 35 is not limited to the assembling structure by the head assembly member.

According to the present modified embodiment, although the print heads 31 to 35 corresponding to four paths are described, a plurality of the head units (HU1, HU11) corresponding to any number of paths can be assembled. Especially, if the head unit (HU11) is used, a print head corresponding to 6 or more paths can be applied.

According to the modified embodiment of the present disclosure, although the print heads 31 to 33 using the head unit (HU1) having one path array (P) and the print heads 34 and 35 using the head unit (HU11) having two path arrays (P) are described, a head unit having three or more path arrays (P) can be used. If a head unit having three or more path arrays is used, there are non-discharging areas between the path arrays like the head unit (HU11).

According to the present modified embodiment, although the same head units (HU1) or head units (HU11) are used to assemble the print head, it is not limited to such assembly. The head units (HU1) and the head units (HU11) can be mixed to assemble the print head.

[Realization of Controller by Software]

Each block of the controller 7, especially the main scan control unit 71, the sub-scan control unit 72, and the discharge control unit 73, can be configured by a hardware logic or by a software using a CPU as follows.

The controller 7 includes the CPU (central processing unit) executing commands of a control program that realize each function of the main scan control unit 71, the sub-scan control unit 72 and the discharge control unit 73, the ROM (read only memory) having the control program, the RAM (Random Access Memory) running the control program, and a memory device (recording media) such as a memory having control programs and various data. The purpose of the present disclosure is to supply to the inkjet printer 1 recording media that record program codes (executing program, mid-code programs, source programs) of the software that realizes such function, which is readable by the computer, and the CPU reads and executes the programs recorded in the recording media.

Examples of the recording media are tapes such as magnetic tapes and cassette tapes, magnetic disks such as floppy disks or hard disks, optical disks such as CD-ROM, MO, MD, BD, DVD, and CD-R, various cards such as IC cards (including memory cards)/optical cards, or semiconductor memories such as mask ROM, EPROM, EEPROM, and flash ROM can be used.

The inkjet printer 1 is connected to communication networks and the program code can be supplied through the communication network. This communication network does not have particular limitations and its examples are internet, intranet, extranet, LAN, ISDN, VAN, CATV communication network, virtual private network, telephone cable network, mobile communication network, satellite communication network, and. Transmitting media for the communication network does not have particular limitations and its examples are wired cables such as IEEE1394, USB, power-line carrier, cable TV wire, telephone cable, and ADSL wire, and wireless cables such as ultraviolet rays like IrDA and remote controller, Bluetooth (trademark), 802.11 wireless, HDR, mobile phone network, satellite cables, and ground wave digital cables. The present invention can be realized by electronic transmission of the program codes such as a carrier wave computer data signal.

[Additional Information]

The inkjet printer 1 according to an embodiment of the present disclosure includes print heads 2, and 31 to 35 and discharge control means 73. The print heads 2, and 31 to 35 include a nozzle array 22 including a plurality of nozzles 21 aligned in a sub-scanning direction (Y) perpendicular to a main scanning direction (X). The discharge control means 73 controls the nozzles 21 to discharge ink droplets such that the nozzles 21 correspond to print data. The inkjet printer 1 performs multipath printing on a print medium 11 with a single scan by moving the print heads 2, and 31 to 35 in the main scanning direction (X) and moving the print heads 2, and 31 to 35 by a band width (BW) in the sub-scanning direction (Y) with respect to the medium 11 after each scan. The inkjet printer 1 according to the embodiment is characterized in that an image to be printed on the print medium 11 is divided to correspond to a plurality of bands. The print heads 2, and 31 to 35 includes a plurality of path arrays (P) arranged in the sub-scanning direction (Y) to correspond to the plurality of bands, respectively, and a plurality of non-discharging areas arranged between the path arrays (P). The inkjet printer 1 is further characterized in that a length (d1, d11) of each non-discharging area in the sub-scanning direction (Y) is greater than a distance (d2) between two adjacent nozzles 21 in a path array.

According to the inkjet printer 1, an image is completed at a band printed by all the path arrays (P) by repeating scanning while moving the print heads 2 and 31 to 35 with respect to the print medium 11. Since a plurality of non-discharging areas are provided between the path arrays (P), a blank line (non-recording area) is recorded on a band formed in a previous scan when a scan is performed in each non-discharging area. For this reason, the end of the band formed in a current scan is misaligned with (located on right of) the end of the band formed in a previous scan as shown in FIG. 5. In addition, since a length (d1, d11) of each non-discharging area in the sub-scanning direction (Y) is greater than a distance between two adjacent nozzles (d2), at least one blank line can be formed. On the other hand, no blank line can be formed when the length of each non-discharging area (d1 and d11) is less than the distance between two adjacent nozzles (d2).

As described above, the end of the band formed in the previous scan is misaligned with the end of the band formed in the current scan even when the print head 2 and 31 to 35 is moved with respect to the print medium 11 in each scan. Therefore, the ends of the bands are not aligned, the boundaries between the bands are not visible and banding is prevented.

The inkjet printer 1 according to the embodiment can be constructed by following construction (1) or (2).

Construction (1)

It is preferred that each non-discharging area includes one or more nozzles 21 and the discharge control means 73 controls such that the nozzles 21 of each non-discharging area correspond to blank line data. When the nozzles 21 of each non-discharging area correspond to the blank line data by the discharge control means 73, the nozzles 21 of each non-discharging area do not discharge any ink droplets. Therefore, different non-discharging areas can be formed in two print heads 2 having identical nozzle arrays 22 based on a print condition by changing nozzles 21 that correspond to the blank line data.

Construction (2)

In this construction, each non-discharging area does not include any nozzle 21. When print heads 2 and 31 to 35 including such non-discharging areas are used, the control of the print heads 2 and 31 to 35 can be simple and efficient because it is not necessary to match the nozzles 21 of each non-discharging area to the blank line data as described above.

The length of each non-discharging area (d1, d11) in the inkjet printer according to Construction (1) or (2) is preferably 10 to 40 times greater than the distance (d2) between two adjacent nozzles.

Alternatively, the print heads 2 and 31 to 35 may preferably include a plurality of head units (HU1, HU11) each of which includes at least one path array (P) and the length (d1, d11) of each non-discharging area in the sub-scanning direction is preferably greater than the distance (d2) between two adjacent nozzles 21.

Due to the reasons described above, a special print head 2 having a single box member including all the path arrays (P) is not required and commonly available small heads 31 to 35 which is generally inexpensive can be used as a head unit (HU1 and HU11). In addition, a print head satisfying various number of paths can be realized by simply changing the number of the head units (HU1, HU11) based on the required number of paths. Furthermore, the print head 31 to 35 can be realized by arranging the head units (HU1 and HU11) in offset positions.

A printing method for an inkjet printer 1 according to another embodiment of the present disclosure will now be described. The inkjet printer 1 includes print heads 2 and 31 to 35 which includes the nozzle array 22 including a plurality of nozzles 21 aligned in the sub-scanning direction (Y) perpendicular to the main scanning direction (X). The inkjet printer 1 controls the nozzles 21 to discharge ink droplets corresponding to print data and performs multipath printing on the print medium 11 with a single scan by moving the print heads 2 and 31 to 35 in the main scanning direction and moving the print heads 2 and 31 to 35 by a band width (BW) in the sub-scanning direction (Y) with respect to the medium 11 after each scan. The printing method is characterized in that bands formed by a same path in each scan are continuously formed on a same layer and an end of a lower band formed in a previous scan is misaligned with an end of an upper band formed on the lower band in a current scan.

According to the printing method described above, an end of the band formed in a previous scan is misaligned with an end of the band formed in a current scan. Since the ends of the bands layered are not aligned, the boundaries of the bands are not visible and banding is prevented.

In the printing method, the nozzle array 21 is preferably divided into a plurality of path arrays (P) (discharging nozzle arrays) and a plurality of skip arrays (S) (non-discharging nozzle arrays). Each skip array (S) corresponds to blank line data and each path array (P) does not correspond to the blank line data such that the skip arrays (S) are arranged between the path arrays (P). Each skip array (S) corresponds to the blank line data such that a distance (d1, d11) between two path arrays (P) is greater than a distance (d2) between two adjacent nozzles 21 in a path array.

Therefore, a blank line (non-recording area) is recorded on a band formed in a previous scan when a scan is performed in each skip array (S). For this reason, the end of the band formed in a current scan is misaligned with (located on right of) the end of the band formed in a previous scan as shown in FIG. 5.

Alternatively, the nozzle array 22 is preferably divided into a plurality of path arrays (P) corresponding to a plurality of bands and may include a plurality of head units (HU1, HU11) each of which includes at least one path array (P). A plurality of non-discharging areas are arranged between the path arrays, and a length (d1, d11) of each non-discharging area in the sub-scanning direction is greater than a distance (d2) between two adjacent nozzles 21 in a path array.

Since a plurality of non-discharging areas are provided between the path arrays (P), a blank line is recorded on a band formed in a previous scan when a scan is performed in each non-discharging area. In addition, since a length (d1, d11) of each non-discharging area in the sub-scanning direction (Y) is greater than a distance (d2) between two adjacent nozzles 21, at least one blank line can be formed. Therefore, the end of the band formed in the previous scan can be misaligned with the end of the band formed in the current scan even when the print head 31 to 35 is moved with respect to the print medium 11 in each scan.

Due to the reasons described above, a special print head having a single box member including all the path arrays (P) is not required and commonly available small heads 31 to 35 which is generally inexpensive can be used as a head unit. In addition, print heads 31 to 35 satisfying various numbers of paths can be realized by simply changing the number of the head units (HU1, HU11) based on the required number of paths. Furthermore, the print head can be realized by arranging the head units in offset positions.

It will be apparent to those skilled in the art that various modifications and variations can be made in the disclosure without departing from the spirit or scope of the disclosures. Thus, it is intended that the disclosure covers the modifications and variations of this disclosure provided they come within the scope of the appended claims and their equivalents.

### INDUSTRIAL AVAILABILITY

Since the inkjet printer of the present disclosure using the multipath printing method prevents banding, it can be properly used as a ultraviolet printer that uses ultraviolet curable ink.

1. An inkjet printer comprising a print head and discharge control means, the print head comprising a nozzle array comprising a plurality of nozzles aligned in a sub-scanning direction perpendicular to a main scanning direction, the discharge control means controlling the nozzles to discharge ink droplets such that the nozzles correspond to print data, the inkjet printer performing multipath printing on a print medium with a single scan by moving the print head in the main scanning direction and moving the print head by a band width in the sub-scanning direction with respect to the medium after each scan, the inkjet printer being characterized in that an image to be printed on the medium is divided to correspond to a plurality of bands, the print head comprises a plurality of path arrays arranged in the sub-scanning direction to correspond to the plurality of bands, respectively, and a plurality of non-discharging areas arranged between the path arrays, and a length of each non-discharging area in the sub-scanning direction is greater than a distance between two adjacent nozzles.

2. The inkjet printer of claim 1, wherein each non-discharging area comprises one or more nozzles and the discharge control means controls such that the nozzles of each non-discharging area correspond to blank line data.

3. The inkjet printer of claim 1, wherein each non-discharging area includes no nozzle.

4. The inkjet printer of claim 2, wherein the length of each non-discharging area is 10 to 40 times greater than the distance between two adjacent nozzles.

5. The inkjet printer of claim 1, wherein the print head comprises a plurality of head units each of which comprises at least one path array and the length of each non-discharging area is greater than the distance between two adjacent nozzles.

6. A printing method for an inkjet printer comprising a print head comprising a nozzle array comprising a plurality of nozzles aligned in a sub-scanning direction perpendicular to a main scanning direction, the inkjet printer controlling the nozzles to discharge ink droplets such that the nozzles correspond to print data and performing multipath printing on a print medium with a single scan by moving the print head in the main scanning direction and moving the print head by a band width in the sub-scanning direction with respect to the medium after each scan, the printing method being characterized in that bands formed by a same path in each scan are continuously formed on a same layer and an end of a lower band formed in a previous scan is misaligned with an end of an upper band formed on the lower band in a current scan.

7. The printing method of claim 6, wherein the nozzle array is divided into a plurality of discharging nozzle arrays and a plurality of non-discharging nozzle arrays, each non-discharging nozzle array corresponds to blank line data and each discharging nozzle array does not correspond to the blank line data such that the non-discharging nozzle arrays are arranged between the discharging nozzle arrays, and each non-discharging nozzle array corresponds to the blank line data such that a distance between two discharging nozzle arrays is greater than a distance between two adjacent nozzles.

8. The printing method of claim 6, wherein the nozzle array is divided into a plurality of path arrays corresponding to a plurality of bands and comprises a plurality of head units each of which comprises at least one path array, a plurality of non-discharging areas are arranged between the path arrays, and a length of each non-discharging area in the sub-scanning direction is greater than a distance between two adjacent nozzles.

9. The printing method of claim 3, wherein the length of each non-discharging area is 10 to 40 times greater than the distance between two adjacent nozzles.
